(19) United States
(12) Patent Application Publication
(10) Pub. No.: US 2009/0305071 A1
(43) Pub. Date: Dec. 10, 2009

(54) Fluoro-compound water repellent composition for wood product dimensional stability

(76) Inventors: Jun Zhang, Getzville, NY (US); Howard Gao, East Amherst, NY (US); Theresa Winstanley, Lewiston, NY (US)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(21) Appl. No.: 12/510,638

(22) Filed: Jul. 28, 2009

Related U.S. Application Data
(63) Continuation of application No. 11/634,712, filed on Dec. 6, 2006, now abandoned.
(60) Provisional application No. 60/742,711, filed on Dec. 6, 2005.

(51) Int. Cl. B27K 3/02; B05D 3/02

(52) U.S. Cl. 428/541; 427/393

(57) ABSTRACT

Provided is a method for improving the dimensional stability of wood and wood products. The method comprises impregnation of wood with fluorocompounds. In one embodiment, the method comprises the impregnation of wood or wood products with a composition comprising fluoro-polymer emulsions and/or dispersions.

This application claims priority to U.S. Provisional application No. 60/742,711 filed on Dec. 6, 2005.

### FIELD OF THE INVENTION

This invention relates to a method for treating wood or a wood products to improve dimensional stability, as well as the wood or wood products so treated. More particularly, the invention relates to the impregnation of wood or wood products with fluorocompounds.

### BACKGROUND

The main components of wood are cellulose, hemicellulose and lignin. The cellulose and hemicellulose contain hydrophilic structures which are mainly hydroxyl groups. The hydroxyl groups have the ability to interact with water molecules to form hydrogen bonds. Wood is capable of absorbing as much as 100% of its weight in water which causes it to swell. Water loss through evaporation results in wood shrinking. This natural water absorption/evaporation process is non-uniform which creates internal stresses in the wood. These internal stresses cause the wood to check, split and warp when exposed to the environment.

Research activities to improve the dimensional stability of wood have increased over the years. Various approaches have been investigated such as reduction of water affinity of wood by means of heat treatment, chemical modification and enzymatic modification of the hydroxyl groups of cellulose or hemicellulose; or provision of a barrier by external or internal coating to reduce water absorption of wood. The greatest amount of research has been in the area of cell wall bulking treatments. The deposition of bulking agents can be achieved by impregnating non-reactive bulking agents into the wood or by impregnating monomers into the wood followed by polymerization of the monomers within the wood. The bulking agents can be water soluble or insoluble, reactive or non-reactive with wood components. The bulking agents known to those skilled in the art include polyethylene glycol (PEG), phenol, resorcinol, melamine and urea-formaldehydes, phenol furfural, furfuryl-analine and furfuryl alcohol and various vinyl resins such as polystyrene, polymethyl methacrylate, polyacrylonitrile, polyvinyl chloride with the help of wood swelling agents.

There are currently three commercial processes available to give dimensional stability to wood. They are thermal treatment, acetylation and furfurylation. The thermal treatment can result in a loss of mechanical strength. Acetylation gives an anti-swelling efficiency (ASE) of 75% with a weight increase of 26% to 28% for softwoods. It requires a heating process following impregnation to start the acetylation reaction. A post treatment process is needed to remove residual acetic acid. The furfurylation can provide an ASE of 60% to wood substrate with a weight gain of 30%. However furfurylation of wood releases volatile organic compound (VOC) during the curing process. The foregoing limitations and the relative complexity of the process reduce its market potential.

Fluoro-compounds are known to those skilled in the art to be able to provide excellent water and oil repellency. There have been efforts of using fluoropolymer to provide oil and water repellency to porous substrates. For example, U.S. Pat. No. 5,156,780 discloses the treatment of micro-porous materials to achieve water and oil repellency while maintaining porosity. In the '780 patent, the substrate is impregnated with a solution of fluoroacrylate monomer in a carrier solvent. The carrier solvent is removed and the fluoroacrylate monomer is polymerized to form a conformal, oil and water repellent coating. The coating is formed internally and externally.

Preparation of Fluoropolymer/Substrate Composition was Disclosed in U.S. Published Application No. 20030162030. The application discloses the polymerization of fluoromonomer into substrates comprising wood and wood by-product. Gaseous and/or liquid fluoromonomers are incorporated into substrate through different processes. The resulted fluoropolymer/substrate network is deposited on the surface of the substrate, as well as at appreciable depths within the substrate. The fluoropolymer networks provide a protective coating for the substrate.

However, the above mentioned approaches require a curing process following impregnation. Furthermore, the processes often use Freon or other volatile organic compounds (VOCs). The relative complexity of the curing processes and the possible release of VOCs limit their potential applications. Therefore, despite the efforts of many inventors, there has been an unmet need to produce aqueous based dimensional stabilization agents that are suitable for the treatment of cellulose-based materials including wood, and other materials to provide exceptional water repellency at very low concentrations with simple application process and low environmental impact, thereby giving a significant reduction of checking and splitting. This need is solved by the subject matter disclosed herein.

### SUMMARY OF THE INVENTION

The present invention relates to fluoro-compound compositions for the treatment of wood and other cellulose materials, and in particular to a composition which can, if desired, be formulated as a concentrate which can be diluted with water, if desired, and used to impregnate wood. The treatment of wood with this system significantly improves the anti-swelling properties of the wood, and thus provides dimensional stability to the wood. The composition comprises an fluorocompound emulsion, dispersion or combination of emulsion and dispersion. Preferably, the fluorocompound is a fluorinated polymer (fluoropolymer) or other fluorinated compound such as a fluorinated oligomer or other fluorocompound. In general, fluoropolymers and other fluorinated compounds having molecular weights above 50, including fluorocarbons such as fluorinated alkanes and alkenes, as well as fluoropolymers having higher molecular weights, such as, for example, greater than 1000, can be used in the present invention.

The term “wood” described in this invention include all forms of wood, such as solid wood, wood composite materials, e.g. wood fiberboard, chipboard, particleboard, and all forms of products made from wood or wood composite materials, such as, for example, mill frames, decking, fencing, siding, siding cladding, roof shingles and utility poles.

In one embodiment, the present invention is directed toward a fluoropolymer concentrate comprising an emulsion and/or dispersion to which water can be added to provide an aqueous system for impregnating wood. Another embodiment of the present invention is a water-added fluoropolymer composition which can be impregnated into wood. The treatment provides water repellency to the wood when it is exposed to water thus providing dimensional stability to the treated products. The composition may also contain biocides to provide mold, fungal, bacterial, and insect resistance. Pigment dispersions and other colorants may be incorporated to provide color and UV stability to treated products as desired.

Surprisingly, the composition provides exceptional anti-swelling efficiency (ASE) and water exclusion efficiency (WEE), even at retentions as low as 0.03 pounds per cubic foot (pcf). Generally, wood treated with the compositions of the present invention have an ASE which is greater than about 50% and a WEE which is greater than about 50%, and which can be greater than about 60% and 70%, respectively, or even much greater.

The fluoro-compound can be obtained from commercially available sources. The fluoro-compound can be anionic, cationic or non-ionic in nature, and water-soluble or present in emulsions/dispersions that contain micronized particles having sizes in the range of from 0.001 microns to 25.0 microns, and preferably between 0.001 to 1.0 microns.

The application of the composition can be by methods known in the art, such as coating, dipping, brushing, spraying, or pressure impregnating, with pressure impregnating preferred. The composition has the ability to form a water repellent film on both the external and internal surfaces of the wood. Internal surfaces can include the interstices of the wood (i.e., the surfaces bounding the interstitial spaces in the wood) such as the lumen and other interior structures. Further, it allows the treated wood substrate to breathe while expelling liquid water that is adsorbed by substrates. The reduction of the moisture gradient between the surface and the internal regions of the substrate leads to reduced stress and improved substrate dimensional stability.

### BRIEF DESCRIPTION OF THE FIGURES

FIG. 1 is a plot of the anti-swelling efficiency (ASE) of E4 wafers treated with a fluoro acrylate copolymer emulsion/dispersion as a function of polymer concentration. The ASE test was conducted according to the procedure described in AWPA Standard E4-78 “Standard Method of Testing Water Repellency of Pressure Treated Wood”.

FIG. 2 is a plot of water exclusion efficiency (WEE) of E4 wafers treated with fluoro acrylate copolymer emulsion/dispersion as a function of chemical concentration. The WEE test was conducted according to the procedure described in AWPA Standard E4-78 “Standard Method of Testing Water Repellency of Pressure Treated Wood”.

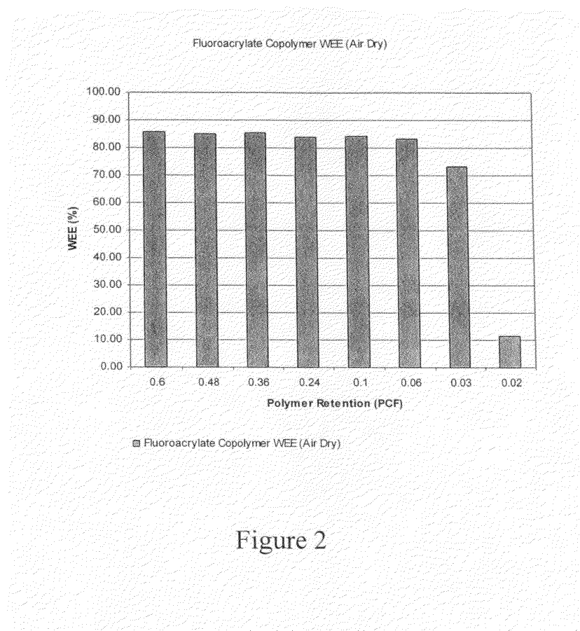

FIG. 3 depicts Coniferous Wood Anatomy.

FIG. 4 depicts the border pit structure for coniferous woods.

### DETAILED DESCRIPTION

The term “water repellent,” unless specifically stated otherwise, is intended to refer to compounds known to those of skill in the art providing water beading property and/or reducing swelling/shrinking to the substrate upon exposure of the substrate to aqueous conditions.

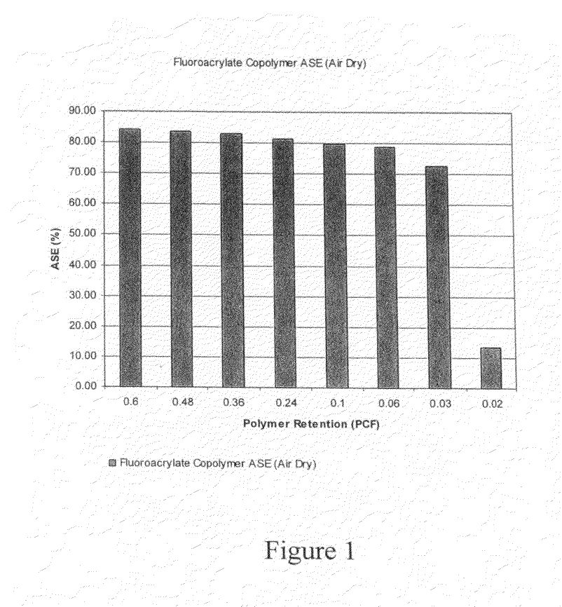

Disclosed herein are fluoro-compound water repellent compositions for use thereof in treatment of cellulosic material, more particularly wood to provide improvement in water repellency and dimensional stability. The composition can be diluted with water to a suitable concentration to achieve desired dimensional stability performance. The compositions can provide water repellency and dimensional stability at very low concentrations as indicated in FIG. 1. Furthermore the present method of improving the dimensional stability of wood can have a reduced presence of residual monomer in the wood than other methods known in the art.

In one embodiment, the term “emulsion” is understood to mean an oil-in-water emulsion in which a component is dispersed in the form of droplets in a continuous aqueous phase. The emulsion can be stabilized by a stabilizer or emulsifier or the like. The term “dispersion” is understood to mean an aqueous dispersion in which a component is present in the form of particles in an aqueous phase. If necessary, the dispersion can be stabilized by a conventional dispersing system known to those skilled in the art.

This invention discloses compositions of aqueous emulsion/dispersion of fluoro-compound for the treatment of wood and other cellulose materials. Impregnation with these compositions provides external and internal protection to wood. The composition may also contain biocides to provide mold, fungal, bacterial, and insect resistance and pigment dispersions to provide color and UV stability when desired. Essentially no VOCs are released, and only standard drying processes are required.

The fluoro-compound component of the composition of this invention preferably comprises a thermoplastic polymeric material in the form of an emulsion/dispersion. In one embodiment, the thermoplastic polymeric material preferably possesses the ability to form a continuous cohesive film after drying. In another embodiment, the polymeric material has a minimum film formation temperature (MFFT), above which a continuous film is formed on the inner surfaces of the wood. Polymers having acrylic moieties often have MFFTs. In order to form this film, the polymeric material can be impregnated into wood which is at a temperature greater than the MFFT, and the film allowed to form spontaneously. Methods for measuring the temperature of wood are well known in the art. In another embodiment, the polymeric material can be applied to wood at a temperature below the MFFT of wood, and the wood can be heated to a temperature greater than the MFFT in order to form the film. The use of coalescing agents can lower the MFFT of a fluoropolymer.

Fluoropolymer emulsions/dispersions suitable for use with this invention are commercially available.

The polymer emulsion/dispersion is comprised of polymer particles which can be stabilized by emulsifying agents. Such emulsifying agents are known in the art. With respect to those fluoropolymers having MFFTs, the particles comprising the emulsion/dispersion or combination thereof fuse together to form a continuous film when the temperature is above the minimum film-forming temperature of the polymer emulsion/dispersion. Such a film is water insoluble; once it is formed thus it is not easily affected by rain wash. If the polymer selected has UV resistance, the combined system can provide long term outdoor performance. Fluoroacrylates are preferred.

The fluoro-compound component of the composition of this invention is obtainable by aqueous emulsion polymerization, or they can easily be purchased from a variety of commercial sources. Fluoropolymer compositions useful for this invention include emulsions and/or dispersions of homopolymers and copolymers of one or more fluorinated monomers and/or other co-monomers. Non-limiting examples of such are tetra-fluoro-ethylene (TFE), vinylidene fluoride (VDF) or chloro-tri-fluoro-ethylene (CTFE) or other fluorinated olefins, perfluorinated olefins, e.g., hexafluoropropene (HFP), fluorinated ethers, especially perfluorinated vinyl-alkyl ethers with alkyls, such as perfluoro-(n-propyl vinyl)ether (PPVE) and perfluoro-(methyl vinyl)ether, fluorinated acrylates and alpha-substituted acrylates, e.g., perfluorohexyl acrylate, perfluoroacetyl acrylate, perfluorodecyl acrylate, perfluorododecyl acrylate, perfluorohexyl methacrylate, perfluoroacetyl methacrylate, perfluorodecyl methacrylate, perfluorododecyl mathacrylate, perfluorohexyl α-fluoroacrylate, perfluorodecyl α-fluoroacrylate, perfluoroheptyl acrylate, perfluoroacetyl acrylate and perfluoroheptyl α-fluoroacrylate.

Suitable co-monomers include vinyl esters of organic and inorganic acids, e.g., vinyl chloride, vinyl bromide, vinyl fluoride, vinyl acetate, vinyl propionate, vinyl stearate and vinyl benzoate; vinyl ethers, e.g., methyl vinyl ether, vinyl ether, n-butyl vinyl ether, decyl vinyl ether, octa decyl vinyl ether, benzyl vinyl ether, phenyl vinyl ether and divinyl ether, alkyl vinyl ketones, alkyl acrylates, alkyl methacrylates, 2-substituted ethyl acrylates or methacrylates, vinylidene halides, acrylonitrile, acrylamide, N-methylol acrylamide, N-methoxy methyl acrylamide, styrene, alkyl styrene, 1,3-butadiene, alkyl esters, alkyl halides, mono- and di-acrylate esters of alkanediols, mono- and di-vinyl esters of alkanedioic acids and the like. The hydrophobe/hydrophile balance of the fluoroacrylate can be modified by incorporating a monomer mixture containing a proportion of 2-hydroxyethylmethacrylate or 2-hydroxyethylacrylate. Polyelectrolyte properties can be introduced by including some acrylic acid, methacrylic acid and carboxyethyl acrylate in the monomer mixture. Cationic sites on the polymer can be provided by tertiary amine substituted acrylic monomers, and so forth.

In addition to the fluoro-homopolymers or fluoro-copolymers described above, low molecular weight fluoro-homopolymeric or fluoro-copolymeric molecules such as fluoro-oligomers may be utilized. By “low” is meant a molecular weight of below about 1000. Thus fluoropolymeric molecules, whether or not they have sufficient molecular weight to qualify as polymers, can be used in the present invention.

The polymer content of the aqueous emulsion/dispersion formulations suitable for the treatment of wood according to the present invention can be about 0.001-50% by weight, and preferably 0.01-30% by weight, relative to the total weight of the dispersion.

The composition according to the invention can also comprise a film-forming auxiliary agent which promotes the formation of a film from the film-forming polymer. Such film-forming agents can be chosen from compounds known to those skilled in the art, and can be chosen in particular from plasticizers and coalescing agents such as, but not limited to, di-n-butyl phthalate and glycol ethers. Such agents allow films to be formed at temperatures below the minimum film-forming temperature of the polymer.

Optionally, a biocide can be added to the above composition to form a preservative system which is suitable to treat and protect wood and other cellulose-based materials from decay and insect attack.

Water soluble or water insoluble organic fungicides, insecticides, moldicides, bactericides, algaecides etc. that can be used with the system are well known to those skilled in the art and include azoles, quaternary ammonium compounds, borate compounds, fluoride compounds disclosed herein and combinations thereof.

Some non-limiting examples of water insoluble organic biocides are as follows.

Aliphatic Nitrogen Fungicides

butylamine; cymoxanil; dodicin; dodine; guazatine; iminoctadine

### Amid Fungicides

carpropamid; chloraniformethan; cyazofamid; cyflufenamid; diclocymet; ethaboxam; fenoxanil; flumetover; furametpyr; prochloraz; quinazamid; silthiofam; triforine benalaxyl; benalaxyl-M; furalaxyl; metalaxyl; metalaxyl-M; pefurazoate; benzohydroxamic acid; tioxymid; trichlamide; zarilamid; zoxamide; cyclafuramid; furmecyclox dichlofluanid; tolylfluanid benthiavalicarb; iprovalicarb; benalaxyl; benalaxyl-M; boscalid; carboxin; fenhexamid; metalaxyl; metalaxyl-M; metsulfovax; ofurace; oxadixyl; oxycarboxin; pyracarbolid; thifluzamide; tiadinil; benodanil; flutolanil; mebenil; mepronil; salicylanilide; tecloftalam fenfuram; furalaxyl; furcarbanil; methfuroxam flusulfamide

### Antibiotic Fungicides

aureofungin; blasticidin-S; cycloheximide; griseofulvin; kasugamycin; natamycin; polyoxins; polyoxorim; streptomycin; validamycin; azoxystrobin; dimoxystrobin; fluoxastrobin; kresoxim-methyl metominostrobin; orysastrobin; picoxystrobin; pyraclostrobin; trifloxystrobin

### Aromatic Fungicides

biphenyl; chlorodinitronaphthalene chloroneb; chlorothalonil; cresol dicloran; hexachlorobenzene; pentachlorophenol; quintozene; sodium pentachlorophenoxide; tecnazene

### Benzimidazole Fungicides

benomyl carbendazim chlorfenazole cypendazole debacarb fuberidazole mecarbinzid rabenzazole thiabendazole

### Benzimidazole Precursor Fungicides

furophanate thiophanate thiophanate-methyl

### Benzothiazole Fungicides

bentaluron chlobenthiazone TCMTB

### Bridged Diphenyl Fungicides

bithionol dichlorophen diphenylamine

### Carbamate Fungicides

benthiavalicarb furophanate iprovalicarb propamocarb thiophanate thiophanate-methyl benomyl carbendazim cypendazole debacarb mecarbinzid diethofencarb

### Conazole Fungicides

climbazole clotrimazole imazalil oxpoconazole prochloraz triflumizole azaconazole bromuconazole cyproconazole diclobutrazol difenoconazole diniconazole diniconazole-M epoxiconazole etaconazole fenbuconazole fluquinconazole flusilazole flutriafol furconazole furconazole-cis hexaconazole imibenconazole ipconazole metconazole myclobutanil penconazole propiconazole prothioconazole quinconazole simeconazole tebuconazole tetraconazole triadimefon triadimenol triticonazole uniconazole uniconazole-P

### Dicarboximide Fungicides

famoxadone fluoroimide chlozolinate dichlozoline iprodione isovaledione myclozolin procymidone vinclozolin captafol captan ditalimfos folpet thiochlorfenphim

### Dinitrophenol Fungicides

binapacryl dinobuton dinocap dinocap-4 dinocap-6 dinocton dinopenton dinosulfon dinoterbon DNOC

### Dithiocarbamate Fungicides

azithiram carbamorph cufraneb cuprobam disulfiram ferbam metam nabam tecoram thiram ziram dazomet etem milneb mancopper mancozeb maneb metiram polycarbamate propineb zineb

### Imidazole Fungicides

cyazofamid fenamidone fenapanil glyodin iprodione isovaledione pefurazoate triazoxide

### Morpholine Fungicides

aldimorph benzamorf carbamorph dimethomorph dodemorph fenpropimorph flumorph tridemorph

### Organophosphorus Fungicides

ampropylfos ditalimfos edifenphos fosetyl hexylthiofos iprobenfos phosdiphen pyrazophos tolclofos-methyl triamiphos

### Oxathiin Fungicides

carboxin oxycarboxin

### Oxazole Fungicides

chlozolinate dichlozoline drazoxolon famoxadone hymexazol metazoxolon myclozolin oxadixyl vinclozolin

### Pyridine Fungicides

boscalid buthiobate dipyrithione fluazinam pyridinitril pyrifenox pyroxychlor pyroxyfur

### Pyrimidine Fungicides

bupirimate cyprodinil diflumetorim dimethirimol ethirimol fenarimol ferimzone mepanipyrim nuarimol pyrimethanil triarimol

### Pyrrole Fungicides

fenpiclonil fludioxonil fluoroimide

### Quinoline Fungicides

ethoxyquin halacrinate 8-hydroxyquinoline sulfate quinacetol quinoxyfen

### Quinone Fungicides

benquinox chloranil dichlone dithianon

### Quinoxaline Fungicides

chinomethionat chlorquinox thioquinox

### Thiazole Fungicides

ethaboxam etridiazole metsulfovax octhilinone thiabendazole thiadifluor thifluzamide

### Thiocarbamate Fungicides

methasulfocarb prothiocarb

### Thiophen Fungicides

ethaboxam silthiofam

### Triazine Fungicides

anilazine

### Triazole Fungicides

bitertanol fluotrimazole triazbutil

### Urea Fungicides

bentaluron pencycuron quinazamid

### Other Fungicides

acibenzolar acypetacs allyl alcohol benzalkonium chloride benzamacril bethoxazin carvone chloropicrin DBCP dehydroacetic acid diclomezine diethyl pyrocarbonate fenaminosulf fenitropan fenpropidin formaldehyde furfural hexachlorobutadiene iodomethane isoprothiolane methyl bromide methyl isothiocyanate metrafenone nitrostyrene nitrothal-isopropyl OCH 2 phenylphenol phthalide piperalin probenazole proquinazid pyroquilon sodium orthophenylphenoxide spiroxamine sultropen thicyofen tricyclazole

Preferred insecticides which can be mixed with polymer emulsion and water repellents are:

### Antibiotic Insecticides

allosamidin; thuringiensin; spinosad; abamectin; doramectin; emamectin; eprinomectin; ivermectin; selamectin; milbemectin; milbemycin oxime; moxidectin

### Botanical Insecticides

anabasine; azadirachtin; d-limonene; nicotine; pyrethrins cinerins; cinerin I; cinerin II; jasmolin I; jasmolin II; pyrethrin I; pyrethrin II; quassia; rotenone; ryania sabadilla

### Carbamate Insecticides

bendiocarb; carbaryl; benfuracarb; carbofuran; carbosulfan; decarbofuran; furathiocarb; dimetan; dimetilan; hyquincarb; pirimicarb; alanycarb; aldicarb; aldoxycarb; butocarboxim; butoxycarboxim; methomyl; nitrilacarb; oxamyl; tazimcarb; thiocarboxime; thiodicarb; thiofanox; allyxycarb; aminocarb; bufencarb; butacarb; carbanolate; cloethocarb; dicresyl; dioxacarb; EMPC; ethiofencarb; fenethacarb; fenobucarb; isoprocarb; methiocarb; metolcarb; mexacarbate; promacyl; promecarb; propoxur; trimethacarb; XMC; xylylcarb

### Dinitrophenol Insecticides

dinex; dinoprop; dinosam; DNOC; cryolite; sodium hexafluorosilicate sulfluramid

### Formamidine Insecticides

amitraz chlordimeform formetanate formparanate

### Fumigant Insecticides

acrylonitrile; carbon disulfide; carbon tetrachloride; chloroform; chloropicrin para-dichlorobenzene; 1,2-dichloropropane; ethyl formate; ethylene dibromide; ethylene dichloride; ethylene oxide; hydrogen cyanide; iodomethane; methyl bromide; methylchloroform; methylene chloride; naphthalene; phosphine; sulfuryl fluoride; tetrachloroethane

### Insect Growth Regulators

bistrifluoron; buprofezin; chlorfluazuron; cyromazine; diflubenzuron; flucycloxuron; flufenoxuron; hexaflumuron; lufenuron; novaluron; noviflumuron; penfluoron; teflubenzuron; triflumuron; epofenonane; fenoxycarb; hydroprene; kinoprene; methoprene; pyriproxyfen; triprene; juvenile hormone I; juvenile hormone II; juvenile hormone III; chromafenozide; halofenozide; methoxyfenozide; tebufenozide; α-ecdysone; ecdysterone; diofenolan; precocene I; precocene II; precocene III; dicyclanil

### Nereistoxin Analogue Insecticides

bensultap; cartap; thiocyclam; thiosultap; flonicamid; clothianidin; dinotefuran; imidacloprid; thiamethoxam; nitenpyram nithiazine; acetamiprid; imidacloprid; nitenpyram; thiacloprid

### Organochlorine Insecticides

bromo-DDT; camphechlor; DDT; pp′-DDT; ethyl-DDD; HCH; gamma-HCH; lindane; methoxychlor; pentachlorophenol; TDE; aldrin; bromocyclen; chlorbicyclen; chlordane; chlordecone; dieldrin; dilor; endosulfan; endrin; HEOD; heptachlor; HHDN; isobenzan; isodrin; kelevan; mirex

### Organophosphorus Insecticides

bromfenvinfos; chlorfenvinphos; crotoxyphos; dichlorvos; dicrotophos; dimethylvinphos; fospirate; heptenophos; methocrotophos; mevinphos; monocrotophos; naled; naftalofos; phosphamidon; propaphos; schradan; TEPP; tetrachlorvinphos; dioxabenzofos fosmethilan phenthoate; acethion; amiton; cadusafos; chlorethoxyfos; chlormephos; demephion; demephion-O; demephion-S; demeton; demeton-O; demeton-S; demeton-methyl; demeton-O-methyl; demeton-S-methyl; demeton-S-methylsulphon; disulfoton ethion; ethoprophos; IPSP; isothioate; malathion; methacrifos; oxydemeton-methyl; oxydeprofos; oxydisulfoton phorate; sulfotep; terbufos; thiometon amidithion; cyanthoate; dimethoate; ethoate-methyl; formothion mecarbam; omethoate; prothoate; sophamide; vamidothion chlorphoxim; phoxim; phoxim-methyl azamethiphos; coumaphos; coumithoate; dioxathion; endothion; menazon; morphothion; phosalone; pyraclofos; pyridaphenthion; quinothion; dithicrofos; thicrofos; azinphos-ethyl; azinphos-methyl; dialifos; phosmet; isoxathion; zolaprofos; chlorprazophos; pyrazophos; chlorpyrifos; chlorpyrifos-methyl; butathiofos; diazinon; etrimfos; lirimfos; pirirniphos-ethyl; pirimiphos-methyl; primidophos; pyrimitate; tebupirimfos; quinalphos; quinalphos-methyl; athidathion; lythidathion; methidathion; prothidathion; isazofos; triazophos; azothoate; bromophos; bromophos-ethyl; carbophenothion; chlorthiophos; cyanophos; cythioate; dicapthon; dichlofenthion; etaphos; famphur; fenchlorphos; fenitrothion; fensulfothion; fenthion; fenthion-ethyl; heterophos; jodfenphos; mesulfenfos; parathion; parathion-methyl; phenkapton; phosnichlor; profenofos; prothiofos; sulprofos; temephos; trichlormetaphos-3; trifenofos; butonate; trichlorfon; mecarphon; fonofos; trichloronat; cyanofenphos; EPN; leptophos; crufomate; fenamiphos; fosthietan; mephosfolan; phosfolan; pirimetaphos; acephate; isocarbophos; isofenphos; methamidophos; propetamphos; dimefox; mazidox; mipafox

### Oxadiazine Insecticides

indoxacarb

### Phthalimide Insecticides

dialifos; phosmet; tetramethrin

### Pyrazole Insecticides

acetoprole; ethiprole; fipronil; tebufenpyrad; tolfenpyrad; vaniliprole

### Pyrethroid Insecticides

acrinathrin; allethrin; bioallethrin; barthrin; bifenthrin; bioethanomethrin; cyclethrin; cycloprothrin; cyfluthrin; beta-cyfluthrin; cyhalothrin; gamma-cyhalothrin; lambda-cyhalothrin; cypermethrin; alpha-cypermethrin; beta-cypermethrin; theta-cypermethrin; zeta-cypermethrin; cyphenothrin; deltamethrin; dimefluthrin; dimethrin; empenthrin; fenfluthrin; fenpirithrin; fenpropathrin; fenvalerate; esfenvalerate; flucythrinate; fluvalinate; tau-fluvalinate; furethrin; imiprothrin; metofluthrin; permethrin; biopermethrin; transpermethrin; phenothrin; prallethrin; profluthrin; pyresmethrin; resmethrin; bioresmethrin; cismethrin; tefluthrin; terallethrin; tetramethrin; tralomethrin; transfluthrin; etofenprox; flufenprox; halfenprox; protrifenbute; silafluofen

### Pyrimidinamine Insecticides

flufenerim; pyrimidifen

### Pyrrole Insecticides

chlorfenapyr

### Tetronic Acid Insecticides

spiromesifen

### Thiourea Insecticides

diafenthiuron

### Urea Insecticides

flucofuron; sulcofuron

### Other Insecticides

closantel; crotamiton; EXD; fenazaflor; fenoxacrim; hydramethylnon; isoprothiolane; malonoben; metoxadiazone; nifluridide; pyridaben; pyridalyl; rafoxanide; triarathene; triazamate

### Preferred Bactericides Include:

bronopol; cresol; dichlorophen; dipyrithione; dodicin; fenaminosulf; formaldehyde; hydrargaphen; 8-hydroxyquinoline sulfate; kasugamycin; nitrapyrin; octhilinone; oxolinic acid; oxytetracycline probenazole; streptomycin tecloftalam thiomersal

Other biocides such as insecticides, mold inhibitors, algaecides, bactericides and the like may also be added to the composition of the present invention.

The biocide dispersions or emulsions can be prepared by standard methods. For example, water insoluble biocide can be incorporated by biocide dispersion made by grinding. They can also be prepared by first dissolving in organic phase and subsequently emulsifying in aqueous medium.

Non-biocidal products such as colorants, emulsion stabilizers, UV inhibitors, and the like may also be added to the system disclosed herein to further enhance the performance of the system or the appearance and performance of the resulting treated products. Such additions may occur in the polymer impregnation step, or they may occur in separate steps which take place before or after the polymer impregnation step.

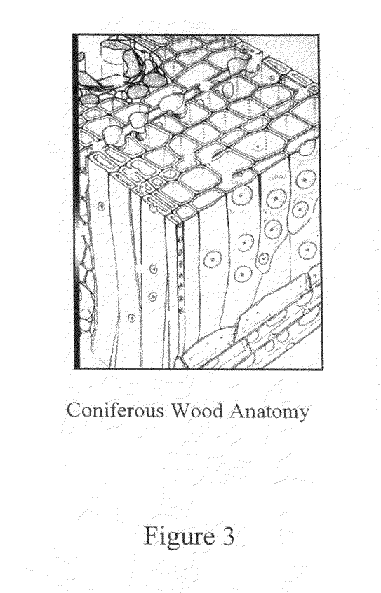

Also important is the penetration of fluoropolymer emulsion/dispersion formulations into the wood's or other cellulose-based material's cellular structure. As shown in FIG. 3, the primary entry and movement of fluids through wood tissue occurs primarily through the tracheids and border pits. Tracheids have a diameter of about thirty microns. Fluids are transferred between wood cells by means of border pits. If the polymer emulsion/dispersion or other additives used in the formulation disclosed herein contain particles having sizes in excess of 30 microns, such particles may be filtered by the surface of the wood (i.e., have limited or no penetration) and thus may not be uniformly distributed within the cell and cell wall. Furthermore, particles having diameters larger than the tracheids diameter may block other particles of smaller size from penetrating the wood.

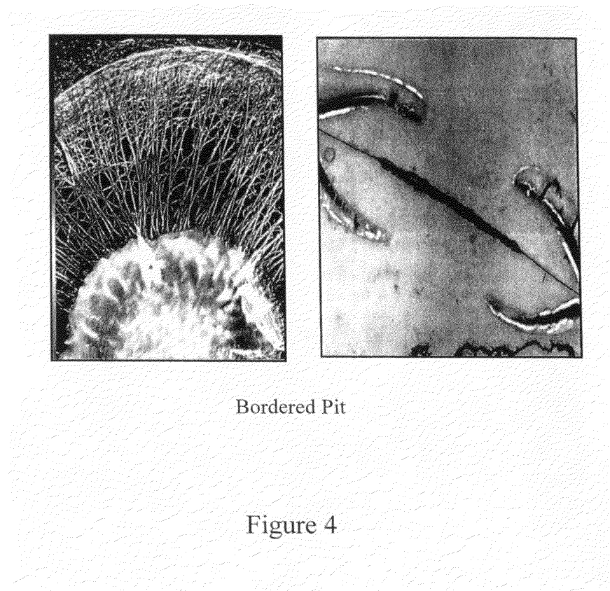

The overall diameter of the border pit chambers typically varies from a several microns up to thirty microns, while the diameter of the pit openings (via the microfibrils) typically varies from several hundredths of a micron to several microns. FIG. 4 depicts the border pit structure for coniferous woods.

Particle size of the fluoropolymer emulsion/dispersion used in the formulation disclosed herein typically does not contain large numbers of particles having diameters in excess of 30 microns or the fluoropolymer emulsion/dispersion tends to be filtered by the surface of the wood, thus not attaining a desired penetration and fluid flow into the wood tissue. In one embodiment, particle size of the fluoropolymer emulsion/dispersion used in the formulation disclosed herein can be between 0.001-10 microns. Particle size of the fluoropolymer emulsion/dispersion used in the dispersion formulation disclosed herein can also be between 0.001-1.0 microns to provide a more uniform penetration of the chemicals into the wood tissue.

The size of the particles used in the dispersion formulation disclosed herein can be micronized, i.e., with a long axis dimension between 0.001-25 microns. In another embodiment, the particle size is between 0.001-10 microns. In another embodiment, the particle size is between 0.01-5 microns. In one embodiment, the particle size is between 0.01 to 2 microns. In yet another embodiment, the particle size is in the range of from 0.05-1 microns.

It should be noted that the above does not exclude the presence of particles outside the stated ranges. However, particles which are too large can clog the wood, preventing it from taking in other particles. Thus particle size distributional parameters can affect the uniformity of particle distribution in the wood, as well as the leaching properties of treated wood. It is thus preferable to use particle size distributions containing relatively few particle sizes outside the range of 0.001 to 25 microns. It is preferred that no more than 20 weight percent of the particles have diameters which are greater than 25 microns. Regardless of the foregoing recommendations, it is generally preferred that at least 60%, and more preferably, at least than 80 wt % of the particles have a diameter in the range of 0.001 to 25 microns. In more preferred embodiments, greater than 85, 90, 95 or 99 wt percent particles are in the range of 0.001 to 25 microns.

In various embodiments, it is preferred that at least 80% of the particles are between 0.001 to 25 microns, or 0.001 to 10 microns or 0.01 to 1.0 microns. For increased degree of penetration and uniformity of distribution, at least 50 wt % of the particles should have diameters which are less than 10 microns. More preferred are particle distributions which have at least 80, 90, 95, or 99 wt % of the particles with sizes of less than 10 microns. In an additional embodiment, at least 60 wt % of the particles should have diameters which are less than 1 micron. More preferred are particle distributions which have at least 80, 90, 95, or 99 wt % of the particles with sizes of less than 1 micron.

It should be noted that other micronized components can be used in addition to fluorocompound emulsions/dispersions and biocides. For example, in one embodiment, the treatment compound can comprise micronized pigment particles. Examples of such pigment include, but are not limited to inorganic pigments such as carbon black, graphite, iron oxide, black micaceous iron oxide, iron hydroxide, zinc oxide, titanium oxide, titanium dioxide, aluminum oxide and aluminum hydroxide; and organic pigments such as organic yellow, red, orange, green, blue, black or brown.

The application of the composition can be dipping, soaking, brushing, spraying, or any other means known to those skilled in the art. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are known to those skilled in the art.

The standard processes are defined as described in AWPA Standard C1-03 “All Timber Products—Preservative Treatment by Pressure Processes”. In the “Empty Cell” process, prior to the introduction of preservative, materials are subjected to atmospheric air pressure (Lowry) or to higher air pressure (Rueping) of the necessary intensity and duration. In the “Modified Full Cell” process, prior to the introduction of preservative, materials are subjected to a vacuum of less than 77 kPa (22 inch Hg, sea level equivalent). A final vacuum of less than 77 kPa (22 inch Hg, sea level equivalent) shall be used. In the “Full Cell” process, prior to the introduction of preservative or during any period of condition prior to treatment, materials are subjected to a vacuum of less than 77 kPa (22 inch Hg). A final vacuum of less than 77 kPa (22 inch Hg) is used.

Examples 1-12, below, are provided to further describe certain embodiment of the disclosure but are in no way limiting the scope of disclosure.

The reduced swelling/shrinking and water absorption were tested according to AWPA Standard E4-78 “Standard Method of Testing Water Repellency of Pressure Treated Wood”. The treating fluids of various formulations at desired concentrations were used to treat southern yellow pine E4 wafers (size: 6.4 mm×25 mm×50 mm, or 0.25 in.×1 in.×2 in., in the longitudinal, radial and tangential directions, respectively). The treating fluids were impregnated into the E4 wafers by vacuum at no less than 25 inch Hg followed by submerging at atmospheric pressure. The solution pickup for each of the treated wafers was recorded and the chemical retention can be calculated from it. The treated wafers were allowed to either air dry or kiln dry and condition in an exhaust hood for 2 weeks.

The water immersion test was used to determine the water repellency of treated wafers. The treated E4 wafers and untreated control wafers were immersed in water for 30 minutes and the tangential swelling of the wafers and the weight gain were measured using a caliper and a balance specified in the standard. The percentage swell is the tangential length percentage increase after soaking in water for 30 minutes. It can be calculated using an average of three wafers from different parent boards. Two important results can be determined from the water immersion test.
1) Anti-swelling efficiency (ASE) is defined as the percentage swell reduced by the treatment versus the untreated controls.

$$ASE ( \% ) = \frac{\begin{matrix}\% Swell of Untreated Control - \\ \% Swell of Treated Sample\end{matrix}}{\% Swell of Untreated Control} \times 100$$

2) Water exclusion efficiency (WEE) is defined as the water absorption reduction by the treatment in percentage in comparison to untreated controls.

$$Wee ( \% ) = \frac{\begin{matrix}\% Wt Gain of Untreated Control - \\ \% Wt Gain of Treated Sample\end{matrix}}{\% Wt Gain of Untreated Control} \times 100$$

Higher ASE and WEE correspond to higher water repellency imparted by the treatment.

### Comparative Example 1

A solution of 2.5% silane/siloxane was made with silane/siloxane concentrate. The diluted silane/siloxane was then used to treat 0.25″×1″×2″ samples of southern pine sapwood E4 wafers, using an initial vacuum of 28″ Hg for 15 minutes, followed by submerging the E4 wafers in the above treating fluid under the atmosphere condition for 20 minutes. The resulting treated wood was weighed and found to have approximately doubled its weight. The samples were air dried and tested for Water Repellency according to AWPA Standard E4-78. The anti-swelling efficiency (ASE) and water exclusion efficiency (WEE) obtained were found to be about 7% and about 56% respectively.

### Example 1

A solution of 0.2% fluoro acrylate copolymer emulsion was made with fluoro acrylate copolymer emulsion concentrate. The diluted polymer emulsion was then used to treat 0.25″×1″×2″ samples of southern pine sapwood E4 wafers, using an initial vacuum of 28″ Hg for 15 minutes, followed by submerging the E4 wafers in the above treating fluid under the atmosphere condition for 20 minutes. The resulting treated wood was weighed and found to have approximately doubled its weight. The samples were air dried and tested for Water Repellency according to AWPA Standard E4-78. The anti-swelling efficiency (ASE) and water exclusion efficiency (WEE) obtained were found to be about 79% and about 83% respectively.

### Example 2

A solution of 0.2% fluoro acrylate copolymer emulsion was made with fluoro acrylate copolymer emulsion concentrate. The above polymer emulsion was then used to treat southern pine sapwood E4 wafers. The resulting treated wood was weighed and found to have approximately doubled its weight. The samples were oven dried and tested for Water Repellency according to AWPA Standard E4-78. The anti-swelling efficiency (ASE) and water exclusion efficiency (WEE) obtained was found to be about 81% and about 85% respectively.

### Example 3

A solution of 0.3% perfluoroalkyl polyacrylate fluoropolymer emulsion was made with perfluoroalkyl polyacrylate fluoropolymer emulsion concentrates. The fluid was then used to treat southern pine sapwood E4 wafers. The resulting treated wood was weighed and found to have approximately doubled its weight. The sample was oven dried. The dried samples were tested for Water Repellency according to AWPA Standard E4-78. The anti-swelling efficiency (ASE) and water exclusion efficiency (WEE) obtained was found to be about 79% and about 85% respectively.

### Example 4

A solution of 0.1% fluoro acrylate copolymer emulsion plus 1% ACQ-D (AWPA P5-04) was made with fluoro acrylate copolymer emulsion and ACQ-D concentrate. The mixture was mechanically stirred for 5 minutes to achieve a homogeneous emulsion/dispersion. The fluid was then used to treat southern pine sapwood E4 wafers. The resulting treated wood was weighed and found to have approximately doubled its weight. The samples were air dried and tested for Water Repellency according to AWPA Standard E4-78. The anti-swelling efficiency (ASE) and water exclusion efficiency (WEE) obtained was found to be about 73% and about 73% respectively.

### Example 5

A solution of 0.3% perfluoroalkyl polyacrylate fluoropolymer emulsion/0.3% DDA carbonate/bicarbonate was made with perfluoroalkyl polyacrylate fluoropolymer emulsion, and DDA carbonate/bicarbonate concentrate. The mixture was mechanically stirred for 5 minutes to achieve a homogeneous emulsion/dispersion. The above fluid was then used to treat E4 wafers. The resulting treated wood was weighed and found to have approximately doubled its weight. The samples were oven dried. The anti-swelling efficiency (ASE) and water exclusion efficiency (WEE) obtained was about 73% and about 73% respectively.

### Example 6

A solution of 0.3% fluoro acrylate copolymer emulsion/0.3% DDA carbonate/bicarbonate was made with fluoro acrylate copolymer emulsion, and DDA carbonate concentrate. The mixture was mechanically stirred for 5 minutes to achieve a homogeneous emulsion/dispersion. The above fluid was then used to treat E4 wafers. The resulting treated wood was weighed and found to have approximately doubled its weight. The samples were air dried. The anti-swelling efficiency (ASE) and water exclusion efficiency (WEE) obtained was about 74% and about 74% respectively.

### Example 7

A solution of 0.08% perfluoroalkyl polyacrylate fluoropolymer emulsion/0.5% chitosan was made with perfluoroalkyl polyacrylate fluoropolymer emulsion, chitosan concentrates. The mixture was mechanically stirred for 5 minutes to achieve a homogeneous emulsion/dispersion. The fluid was then used to treat samples of southern pine sapwood E4 wafers. The resulting treated wood was weighed and found to have approximately doubled its weight. The samples were oven dried and tested for Water Repellency according to AWPA Standard E4-78. The anti-swelling efficiency (ASE) and water exclusion efficiency (WEE) obtained was found to be about 60% and about 80% respectively.

### Example 8

A solution of 0.1% fluoro acrylate copolymer emulsion/0.5% chitosan was made with fluoro acrylate copolymer emulsion, chitosan concentrates. The mixture was mechanically stirred for 5 minutes to achieve a homogeneous emulsion/dispersion. The fluid was then used to treat samples of southern pine sapwood E4 wafers. The resulting treated wood was weighed and found to have approximately doubled its weight. The samples were air dried and tested for Water Repellency according to AWPA Standard E4-78. The anti-swelling efficiency (ASE) and water exclusion efficiency (WEE) obtained was found to be about 70% and about 86% respectively.

### Example 9

A solution of 2% fluoro acrylate copolymer emulsion, 0.4% amine oxide, 0.4% DDA carbonate and 0.3% pigment dispersion was made with fluoro acrylate copolymer emulsion, amine oxide, DDA carbonate and pigment dispersion concentrates. The diluted treating composition was then used to treat 1″×6″×10″ samples of southern pine sapwood E4 wafers, using an initial vacuum of 28″ Hg for 20 minutes, followed by submerging the E4 wafers in the above treating fluid under the atmosphere condition for 30 minutes. The resulting treated wood was weighed and found to have approximately doubled its weight. The samples were air dried and exposed outdoors for weathering evaluations.

### Example 10

A solution of 6% fluoro acrylate copolymer emulsion, 0.1% micronized Cu-8 and 0.3% pigment dispersion was made with fluoro acrylate copolymer emulsion, micronized Cu-8 dispersion and pigment dispersion concentrates. The diluted treating composition was then used to treat 1″×6″×10″ samples of southern pine sapwood E4 wafers, using an initial vacuum of 28″ Hg for 20 minutes, followed by submerging the E4 wafers in the above treating fluid under the atmosphere condition for 30 minutes. The resulting treated wood was weighed and found to have approximately doubled its weight. The samples were air dried and exposed outdoors for weathering evaluations.

### Example 11

A solution of 4% fluoro acrylate copolymer emulsion, 0.1% tebuconazole emulsion, 0.02% bifenthrin emulsion and 0.3% pigment dispersion was made with fluoro acrylate copolymer emulsion, tebuconazole emulsion, bifenthrin emulsion and pigment dispersion concentrates. The diluted treating composition was then used to treat 1″×6″×10″ samples of southern pine sapwood E4 wafers, using an initial vacuum of 28″ Hg for 20 minutes, followed by submerging the E4 wafers in the above treating fluid under the atmosphere condition for 30 minutes. The resulting treated wood was weighed and found to have approximately doubled its weight. The samples were air dried and exposed outdoors for weathering evaluations.

### Example 12

A solution of 14% fluoro acrylate copolymer emulsion, 0.1% micronized tebuconazole, 0.02% bifenthrin emulsion and 0.3% pigment dispersion was made with fluoro acrylate copolymer emulsion, micronized tebuconazole, bifenthrin emulsion and pigment dispersion concentrates. The diluted treating composition was then used to treat 1″×6″×10″ samples of southern pine sapwood E4 wafers, using an initial vacuum of 28″ Hg for 20 minutes, followed by submerging the E4 wafers in the above treating fluid under the atmosphere condition for 30 minutes. The resulting treated wood was weighed and found to have approximately doubled its weight. The samples were air dried and exposed outdoors for weathering evaluations.

Although specific embodiments have been described herein, those skilled in the art will recognize that routine modifications can be made without departing from the spirit of the invention.

1. A method for improving the dimensional stability of wood, the method comprising the steps of:
providing a composition comprising a fluoropolymer emulsion or dispersion;
applying the fluoropolymer composition to wood such that the wood is at least partially impregnated with the fluoropolymer;
wherein the wood has a minimum ASE and WEE of 40% of 40%, respectively.

2. A method as in claim 1 wherein the composition providing wood with an ASE of 50% to 75% and a WEE of 55% to 85%.

3. A method as in claim 1 wherein the composition providing wood with ASE of above 85% and a WEE of above 90%.

4. A method as in claim 1 wherein after treatment, the retention level of the polymer in the wood is in the range of from about. 0.01 to 20 pcf.

5. A method as in claim 4 wherein after treatment, the retention level of the polymer in the wood is in the range of from about 0.1 to 10 pcf.

6. A method as in claim 5 wherein after treatment, the retention level of the polymer in the wood is in the range of from about 1 to 5 pcf.

7. A method as in claim 1 wherein concentration of polymer in the treatment solution is in the range of from 0.01 wt % to 50 wt %.

8. A method as in claim 7 wherein concentration of polymer in the treatment solution is in the range of from 0.1 wt % to 25 wt %.

9. A method as in claim 8 wherein concentration of polymer in the treatment solution is in the range of from 1 wt % to 15 wt %.

10. A method as in claim 1 wherein the fluoropolymer emulsion or dispersion comprises one or more fluorinated olefins, perfluorinated olefins, fluorinated ethers, fluorinated acrylates or alpha-substituted acrylates.

11. A method as in claim 1 wherein the fluoropolymer emulsion or dispersion comprises hexafluoropropene (HFP), perfluoro-(n-propyl vinyl)ether (PPVE), perfluoro-(methyl vinyl)ether, perfluorohexyl acrylate, perfluoroacetyl acrylate, perfluorodecyl acrylate, perfluorododecyl acrylate, perfluorohexyl methacrylate, perfluoroacetyl methacrylate, perfluorodecyl methacrylate, perfluorododecyl mathacrylate, perfluorohexyl α-fluoroacrylate, perfluorodecyl α-fluoroacrylate, perfluoroheptyl acrylate, perfluoroacetyl acrylate or perfluoroheptyl α-fluoroacrylate.

12. A method as in claim 1 wherein said fluoropolymer further contains co-monomers.

13. A method as in claim 12 wherein the co-monomers include vinyl esters of organic and inorganic acids; vinyl ethers; alkyl vinyl ketones; alkyl acrylates; alkyl methacrylates; vinylidene halides; acrylonitrile; acrylamide; N-methylol acrylamide; N-methoxy methyl acrylamide; styrene; alkyl styrene; 1,3-butadiene; alkyl esters; alkyl halides; mono- or di-acrylate esters of alkanediols; mono- or di-vinyl esters of alkanedioic acids, vinyl chloride; vinyl benzoate; methyl vinyl ether; or divinyl ether, 2-hydroxyethyl methacrylate, 2-hydroxyethyl acrylate, acrylic acid, methacrylic acid, carboxyethyl acrylate, or a tertiary amine-substituted acrylic monomer.

14. A method as in claim 1 wherein said composition further comprises one or more biocides.

15. A method as in claim 14 wherein one or more of said biocides comprises micronized particles.

16. A method as in claim 15 wherein said composition further comprises one or more copper compounds; one or more zinc compounds; tebuconazole; bifenthrin; dimethyl didecyl ammonium carbonate/bicarbonate; dimethyl didecyl ammonium chloride; propiconazole; cyproconazole; 4,5 Dichloro-2-N-Octyl-4-isothiazolin-3-one (rh-287) imidacloprid; fipronil; permethrin; or cypromethrin.

17. A method as in claim 16 wherein said composition comprises copper hydroxide, copper oxide, copper carbonate, basic copper carbonate, copper 8-hydroxyquinolate, zinc oxide, zinc phosphate, zinc borate or zinc carbonate.

18. A method as in claim 1 wherein the method further comprises the step of treating the wood with a biocide.

19. A method as in claim 1 wherein the fluoropolymer has a minimum film formation temperature and wherein the wood has a temperature at or above the minimum film formation temperature of the fluoropolymer.

20. A method as in claim 1 wherein the fluoropolymer has a minimum film formation temperature, and wherein the wood is impregnated at a temperature below the minimum film formation of the fluoropolymer; wherein said method additionally comprises a step for heating the wood to a temperature above the minimum film formation of the fluoropolymer after the impregnation of the wood with the fluoropolymer.

21. A method as in claim 1 wherein the composition comprises a coalescing compound which facilitates the formation of a film on the interior surfaces of the wood.

22. A method as in claim 1 wherein said fluoropolymer comprises a dispersion or an emulsion of particles or droplets, wherein greater than 60 wt % of said particles having sizes in the range of from 0.001 to 25 microns.

23. A method as in claim 1 wherein said composition further comprises micronized pigment particles.

24. A method as in claim 23, wherein the pigment comprises carbon black, graphite, iron oxide, black micaceous iron oxide, iron hydroxide, zinc oxide, titanium oxide, titanium dioxide, aluminum oxide and aluminum hydroxide; or organic yellow, red, orange, green, blue, black or brown.

25. Wood which has been impregnated by the method of claim 1.

26. Wood which has been impregnated by the method of claim 14.
